(19) United States
(12) Patent Application Publication
(10) Pub. No.: US 2009/0177635 A1
(43) Pub. Date: Jul. 9, 2009

(54) System and Method to Automatically Enhance Confidence in Intellectual Property Ownership

(75) Inventors: Mahshad KOOHGOLI, Kanata (CA); Kia MOUSAVI, Ottawa (CA); Dhananjay GODSE, Kanata (CA)

Correspondence Address: FREEDMAN & ASSOCIATES, 117 CENTREPOINTE DRIVE, SUITE 350, NEPEAN, ONTARIO, K2G 5X3, CA

(73) Assignee: PROTECODE INCORPORATED, Ottawa (CA)

(21) Appl. No.: 12/350,490

(22) Filed: Jan. 8, 2009

Related U.S. Application Data
(60) Provisional application No. 61/006,362, filed on Jan. 8, 2008.

(51) Int. Cl. G06F 7/06; G06F 17/30

(52) U.S. Cl. 707/3; 707/E17.108

(57) ABSTRACT

A system and method for documenting intellectual property ownership of digital content is described. The approach includes initializing an annotation, within or associated with the digital content, within a system with a reliable reference of authorship, ownership, and licensure to a first portion of the digital content and unverified claims of authorship, ownership, and licensure to a second portion of digital content. The invention also provides a system and method to augment and update these records by adding additional claims of ownership, authorship, and licensure over time or amending them based upon interactions with centralized repositories of digital content. The system and method also provide for determining the confidence in the ownership of the digital content.

### FIELD OF THE INVENTION

The invention relates to accessing digital content and more particularly to mediating access to private and public digital content repositories.

### BACKGROUND OF THE INVENTION

Digital content has been developed for as long as computers have been around. It exists in the form of computer programs, text documents, digital images, digital video, digital audio, software components, and blocks of computer code. Digital content producers integrate, compile and distribute digital content production to end-users. Examples of such producers include software vendors, web site designers, and audiovisual content producers. During recent years, organizations producing digital content have chosen to leverage externally developed content to gain efficiency in research and development. As a result, some organizations have chosen to develop digital content components for distribution not to end-users but to other digital content producers. For example, some companies sell digital photographs to web-site designers/producers for use in their web sites. Another class of content producer has emerged that has chosen to produce digital content or digital content components and then distribute them for free or with liberal licenses. A subset of these free content developers has chosen to distribute their content freely, but licensed in a way that requires content producers using the free content, either directly or to produce derivative works, to release their work under the same terms. Another trend in content development is the advent and increasing use of the Internet and the world-wide web.

Through the Internet, finding digital content has become easier and faster. To the extent that it is often expedient for digital content developers and their companies to acquire digital content or digital content components from third parties, it has become acceptable to do so for producing a derivative work, rather than producing all digital content internally. Alternatively developers are increasingly merging externally sourced digital content, or digital content components, and embedding them within their own digital content. For example, a developer generating software for an MP3 music player might download and embed search programming code, allowing the user to easily search for the song they want, or an enhanced display driver produced by another developer already using the same LCD display.

Whilst the increased breadth and speed of access globally to digital content has significantly eased the digital content development process, commercial enterprises now face a problem relating to intellectual property and licensing. An ability to establish the intellectual property rights of digital content increases in complexity as developers select and embed more content from many different sources into the digital content of a commercial enterprise. In some instances, with multiple development teams globally distributed to provide 24 hour code development or addressing multiple elements of the digital content, managing the intellectual property rights thereof becomes nearly unimaginable.

Knowing these intellectual property rights is crucial when establishing the valuation of businesses that derive revenue from generating and distributing original digital content, such as software companies, or companies that use digital content to derive revenue or cut costs, such as television broadcasters. When a business is being audited and evaluated, accurate records detailing all external digital content in the digital content systems is requested. These records include copyright ownership details, license agreements, and other terms and conditions. Given that it only takes seconds to copy significant amounts of external digital content into the digital content of a commercial enterprise, monitoring and reporting of these property rights is difficult.

For a digital content provider a typical high-level process for documenting external content is as follows:
Go through the digital content to identify and document each piece of known external digital content;
For each identified piece try to determine a source and, when a source is likely to be correct annotate the content with copyright owner, license, author(s), etc;
Compare all of your content with publicly comparable content, and if there is a match annotate the content with copyright owner, license, author(s);
For the remaining external content still not annotated, annotate them manually to the best of your ability with the copyright owner, license, author(s), etc.

Intellectual property lawyers and software experts are often brought into the digital content developer business to drive this process; key content developers and project leaders spend much time compiling these lists and reports. In reality this process is often prohibitively expensive because it requires manual labor and guesswork by highly qualified and expensive intellectual property lawyers and content developers. It is also error-prone, and subject to abuse by developers intent on hiding the source of their specific portions of the overall code forming the digital content offered by their employer or contract provider.

Additionally a large volume of digital content, such as for example a software suite or video game, may have a significant number of inserted portions of external content from a similarly large number of sources. Many such sources may in fact be private repositories of digital content, individuals developing digital content or other sources which are difficult to locate, access and verify that the digital content they host was employed within the produced digital content.

It would be advantageous to overcome some of the drawbacks of the prior art.

### SUMMARY OF THE INVENTION

In accordance with an aspect of the invention there is provided a method comprising: providing a data store comprising first data stored therein, the first data comprising a plurality of records, each record having a search criteria relating to digital content and annotation data associated therewith relating to at least one of a pedigree of the digital content, licensing information relating to the digital content, and an owner of copyright in the digital content; receiving a request comprising one of receiving first digital content and determining first search criteria therefrom and receiving first search criteria derived from first digital content; searching the first data to retrieve annotation data associated with the first search criteria; and, responding to the request with annotation data associated with the first search criteria.

In accordance with an aspect of the invention there is provided system comprising: a central server in communication with a communication network for storing of search data relating to digital content and annotation data in association with the search data and for accessing another server in communication with the network to retrieve annotation data therefrom in response to a request of a user, the annotation data retrieved from the another server and relayed to the user.

In accordance with an aspect of the invention there is provided system comprising: computer hardware in communication with a network and for: providing a data store comprising first data stored therein, the first data comprising a plurality of records, each record having a search criteria relating to digital content and annotation data associated therewith relating to at least one of a pedigree of the digital content, licensing information relating to the digital content, and an owner of copyright in the digital content; receiving a request comprising one of receiving first digital content and determining first search criteria therefrom and receiving first search criteria derived from first digital content; searching the first data to retrieve annotation data associated with the first search criteria; and, responding to the request with annotation data associated with the first search criteria.

The entire contents of co-pending U.S. patent application Ser. No. 12/292,180, entitled “System and Method for Capturing and Certifying Digital Content Pedigree” and filed on Nov. 13, 2008 in the name of Mousavi et al., are incorporated herein by reference.

### BRIEF DESCRIPTION OF THE DRAWINGS

Embodiments of the invention will now be described in conjunction with the following drawings, in which:

FIG. 1 depicts a boundary between known external content and unknown external content;

FIG. 2A depicts an embodiment of the invention in respect of publicly comparable content in the context of two content developers and a public signature repository;

FIG. 2B depicts a boundary between publicly comparable content and publicly uncomparable external content; FIG. 3 depicts the combination content assignment from gathering external content records, public comparison based annotation content, and best effort annotation content;

FIG. 4 depicts an embodiment of the invention by a flow diagram for updating an electronic content file of electronic content in response to annotating the digital content file with licensing/copyright information associated with the digital content and confidence in such licensing/copyright information;

FIG. 5 illustrates an embodiment of the invention by outlining the format of an electronic shadow file format and electronic shadow file signatures generated from it wherein annotating the digital content file directly with licensing/copyright information associated with the digital content and confidence in such licensing/copyright information results in the electronic shadow file being updated accordingly;

FIG. 6 depicts a schematic for the various levels of confidence in copyright ownership of a digital content file;

FIG. 7 depicts a simplified flow diagram for establishing independent measure of confidence in the annotations added to an electronic content file such as presented in respect of FIG. 4, the independent measure of confidence based upon interrogating a centralized electronic signature repository; and,

FIG. 8 depicts an embodiment of the invention by a web searching approach to extracting and identifying electronic content to provide a centralized electronic signature repository which is then employed in establishing independent confidence of electronic content file content.

### DETAILED DESCRIPTION OF EMBODIMENTS OF THE INVENTION

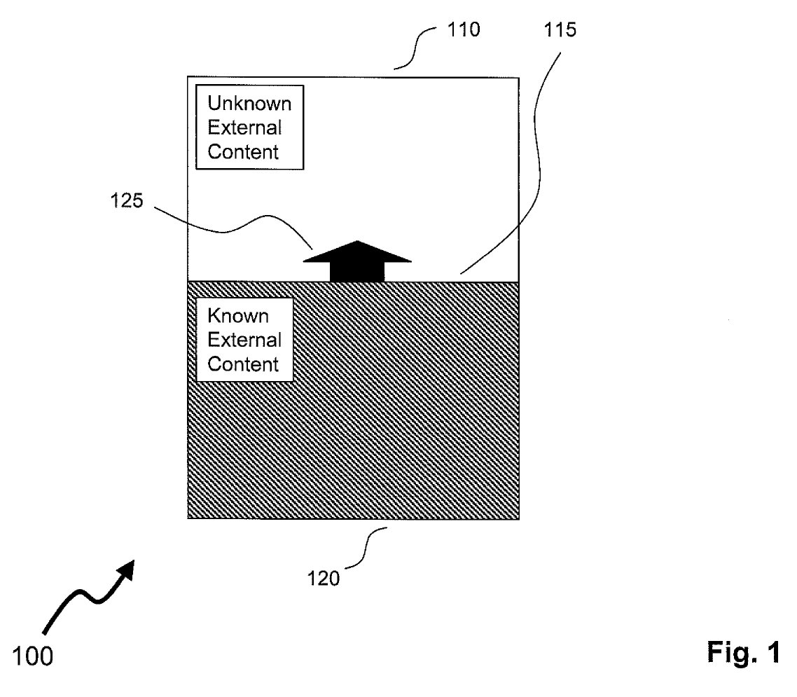

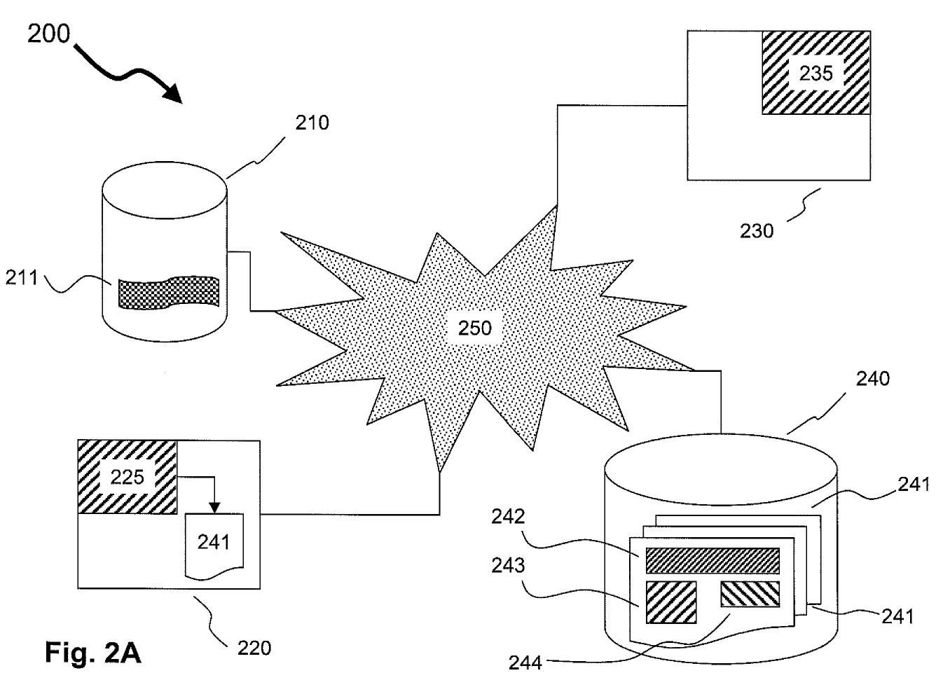

Referring to FIG. 1 there is depicted a schematic 100 of known external content 120 and unknown external content 110. Each of the known external content 120 and unknown external content 110 comprise electronic content exploited by a developer of electronic content that it did not develop itself. Examples of such external content include fully formed source code files, subroutines or partial source code files, images, audiovisual content, and software libraries. Optionally, the external content includes partial data buffers storing displayed code, code snippets, image snippets, and audiovisual clips.

The schematic 100 in depicting known external content 120 and unknown external content 110 represents a portion of electronic content for which establishing proper ownership and licensure of intellectual property remains necessary. The arrow 125 represents a desire to improve identification of external content in order to reduce an amount of unknown external content and a commercial risk to the developer. Within the prior art, a typical process for moving arrow 125 higher and reducing the unknown external content 110 comprises having the software design team gather a list of third party components and licenses, providing the list to the lawyers, and then verifying ownership. Typically, such a list suffers from several flaws including:
Did the designers remember to include everything?
Did the designers deliberately not include something?
Entire packages (e.g. Apache Web Server, SQLite, Log4J) are easy to remember, but did the software design team report all sub-systems or code snippets from within these well-known packages or from other sources of software?
Were 3rd party libraries and runtime systems included?
Were libraries included with the host operating system included?
Were redistributable libraries from the operating system or tool chain included?

Even where all such external content is reported, additional errors in the software design team reporting often occur as the actual external content whilst identified may actually have been sourced from another external source than the specific one used by the developer. In such instances the external content source is potentially different from what is indicated, and may require a completely different licensing agreement.

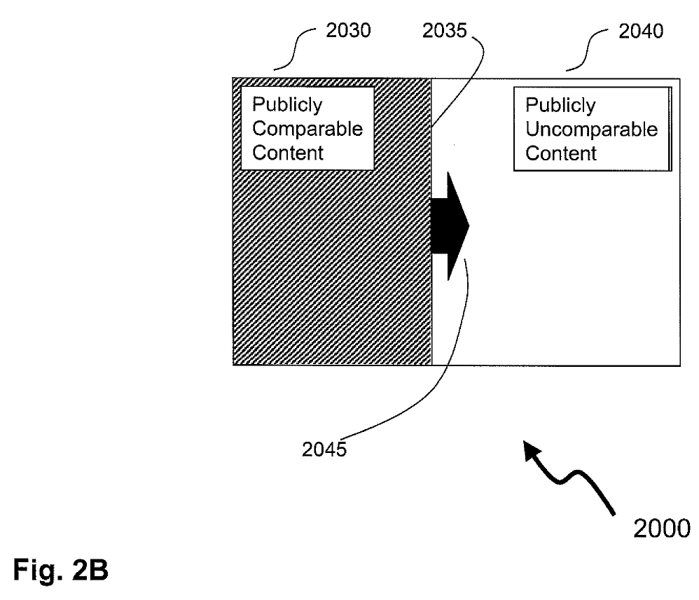

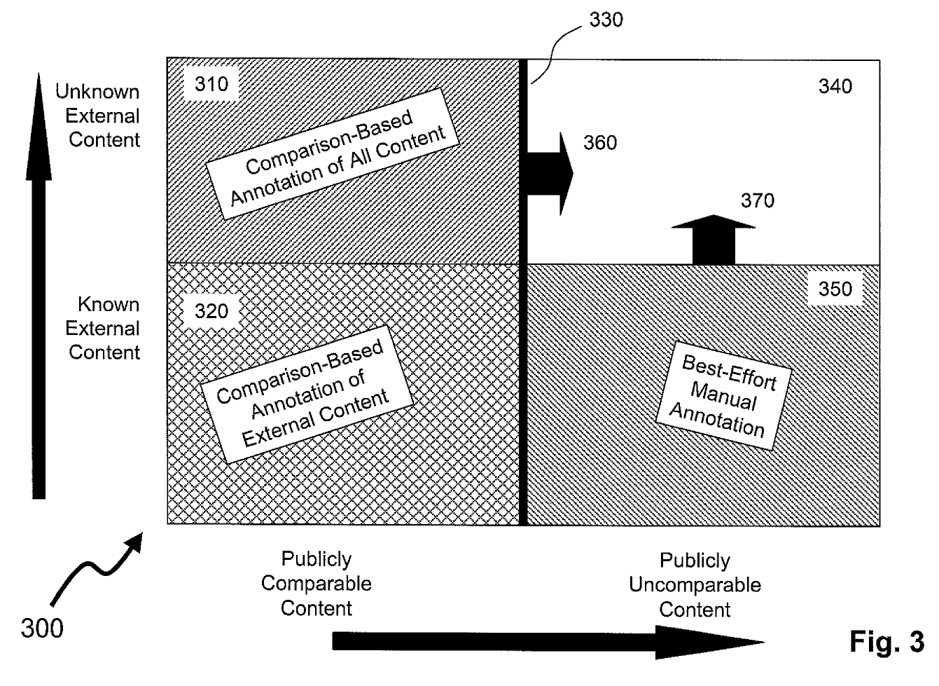

Accordingly, it would be advantageous to provide a system and method for verifying and validating external content by providing for publicly comparable content 211 as depicted within development environment 200 of FIG. 2A. Publicly comparable content 211 is electronic content that can be “compared” to without requiring the owner of the publicly comparable content to grant access to the comparison mechanism. For example, the Linux kernel is one example of publicly comparable content 211 and may be downloaded from public servers 210. Developers compare both files and source code to the Linux kernel software without requiring the owners of Linux to grant permission. Typically, for content to be publically comparable, the source code therefore is publically available for analysis.

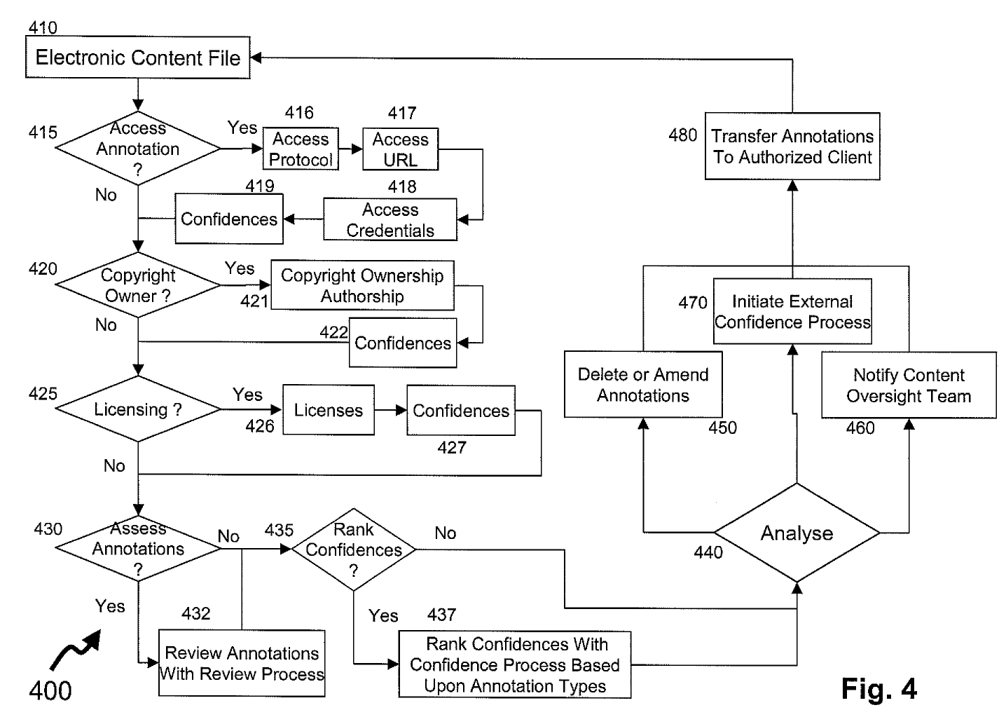

Private content is more difficult to compare since the content itself is not publically available. Keeping content private is often desirable since it prevents analysis, reverse engineering, and copying of source code. According to an embodiment of the invention comparing private content is achieved by generating a one way hash in the form of a one-way compact message digest of the private content and storing only the digest, in the form of an electronic signature 241, on a public server 240. As shown in development environment 200 a content development company A 220 has a source code file 225 that includes proprietary algorithms. Accordingly, company A 220 generates an electronic signature 241 using one signature algorithm, for example Message-Digest algorithm 5 (MD5), Secure Hash Algorithm (SHA) such as SHA1, or according to the embodiments hereindescribed in respect of FIGS. 4 to 6. The electronic signature 241 is then stored on a known public server 240. Stored within each electronic signature 241 is the signature of the private content 242, the name and contact information 243 of the copyright owner along with licensing information 244 when available.

As a result, at a later point in time company B 230 has obtained a copy 235 of source code file 225, be it legally or otherwise. Company B 230 signs the copy 235 and provides it to the public server 240 for comparison. With matching signatures 241 then company B 230 knows that company A 220 has a claim to that digital content 235. Additionally company B 230 also has the ability to contact company A 220 via the name and contact information 243 and already knows the appropriate licensing information 244 when available.

As shown in second schematic 2000 of FIG. 2B depicting publicly comparable content 2030 and publicly uncomparable content 2040 there is outlined a boundary 2035 between the portion of the electronic content for which the developer can establish claimed ownership and licensure of intellectual property and that which they cannot. The trend arrow 2045 represents a desire to improve the identification of external content by public comparison in order to reduce an amount of unknown external content and commercial risk to the developer.

As described supra in respect of FIG. 2A the association of ownership and licenses with external content incorporated in a developer's electronic content increases the probability for a business that its developed electronic content is free of intellectual property conflicts. This process is described hereinafter as annotation and comprises two forms of annotation—comparison-based annotation and best-effort annotation.

Company B 230 having established an external content list that it believes to be complete from its development team then undertakes a comparison-based annotation with publicly comparable content. Firstly, for each element in the external content list, company B 230 compares and cross-references the external content to a public repository of known external content to see if there is a match at some acceptable level of granularity. Optionally, this is performed by comparing the electronic content 235 and/or an electronic signature 241. If there is a match, then company B annotates their content with the source, copyright ownership 243, and license information 244, when available, of matching publicly comparable content.

However, it would be beneficial for company B 230 to verify all content, and not just that identified within the external content list of its development team. Thus company B compares all or portions of its electronic content to a public repository 240 of known external content 241 to see if there is a match within predetermined limits. If there is a match, then this content is also annotated as to source, copyright ownership 243, and license information 244, when available, of the publicly comparable content that matched.

Referring to combination effect schematic 300 of FIG. 3, performing both verifications results in comparison-based annotation of external content 320 as disclosed by its development team and comparison-based annotation of all content 310. As shown boundary 330 does not sit to the extreme night of the combination effect schematic 300 indicating that there is still external content that didn't have a publicly comparable owner. To complete the process, best-effort annotation 350 is performed by company B 230. In this best-effort annotation, for each element in the external content list that didn't match to publicly comparable content, company B 230 annotates the content, author, copyright ownership, and license to the best of its ability. Of course, as available publically comparable content increases and as annotations of that content become verified, boundary 330 will move further to the right when the above noted method is employed.

Moreover, as shown by the arrows 360 and 370 in the combination-effect schematic 300, as the methods of external content identification improve and the amount of publicly comparable software improves, the amount of unknown external content 340 that is publicly uncomparable diminishes, thus reducing the risks of intellectual property liability. However, many aspects of the approach presented supra in respect of FIGS. 2A to 3 rely upon the intentions of the electronic content development team being aligned with those of company B 230.

According to various embodiments of the invention described below a mechanism of tracking the development of an electronic content from a development team is presented. These embodiments are presented and described with respect to two fundamental units of intellectual property in respect of electronic content in a system, from a single computer under the control of a single developer to a distributed development team operating globally across multiple server farms, the Internet and computer systems.

The first fundamental unit is a file. Ultimately, electronic content depends on combining one or more files. These optionally include, but are not limited to, source code files, build scripts, images, audio files, video files, binary files, and software libraries. According to an embodiment creation, import, deletion, modification, moving, and renaming of all files used to build a system of electronic content such as a software application or subsystem are detected and processed. Any new file, which is optionally electronic content over a specified predetermined size limit, is logged as external content associated with that file.

The second fundamental unit is a buffer. In some cases external content is brought into a system by cutting and pasting from other sources such as a web browser, a file browser, or from within a content-specific editor or viewer. Ultimately, each such cut-and-paste operation involves the transfer of a buffer of data from an external source into the electronic content file, which is a loggable event. In this manner any new buffer, for example beyond a predetermined size, that is introduced into the monitored electronic content file is logged as external content associated with that file.

Similarly there are elements that are optionally not captured. The first one is the location of either the external content or the electronic content within a file system, in that the location within the file system does not need generally to be logged. Alternatively, logging of the location is performed in some circumstances, such as associating a specific electronic content to a client. For example the licensing requirements of electronic content are likely to be substantially different when the electronic content is sold to an industry leading content provider, such as Microsoft, Apple, Yahoo, and Google, versus distributing same globally to individuals.

Secondly, certain file types are optionally not captured. Even in the file-system locations, folders or directories, that are monitored for the events such as creation, import, deletion, modification, moving, and renaming together with the embedding of external content, there exist some files of specific types that do not ultimately lead to the production of the electronic content or electronic content system, and therefore do not need to have their file-system events monitored. Examples include, but are not limited to, hidden files put in every project directory by source file version control systems such as Concurrent Versions System (CVS), or Subversion (SVN) initially released in 2000 by CollabNet Inc. Alternatively, the automated external content monitoring and electronic content tracking is performed with a configuration that does not ignore file-system events for these types of files.

It would be understood by one skilled in the art that the automatic logging of incoming external content increases confidence in completeness of an external content log.

Referring to FIG. 4 an exemplary flow diagram 400 is shown for annotation during updating an electronic content file of electronic content with licensing/copyright information associated with the digital content and confidence in such licensing/copyright information. At 410 an electronic content file is accessed by a member of a development team generating the electronic content file. The access is to allow the development team and their management to assess a confidence level that the electronic content is not infringing another parties intellectual property rights.

At step 415 the programmer responds to a prompt in respect of whether external electronic content has been added. If the answer is no then the annotation flow diagram 400 moves directly to a copyright prompt at 420. If the answer is yes then the annotation flow diagram 400 moves to 416 wherein the programmer enters the access protocol of the external electronic content, then at 417 enters the Universal Resource Locator (URL) indicating the address from which the external electronic content was extracted, before moving to 418 wherein the access credentials necessary to retrieve the external electronic content from the URL address are entered. Finally the annotation flow diagram 400 moves to 419 wherein the programmer is prompted to enter a confidence level of the information they have provided in 416 through 418, respectively.

Upon completion of 419 the annotation flow diagram 400 continues at 420 wherein the programmer is prompted for whether copyright information on the external electronic content is available. If the programmer response is negative then the annotation flow diagram 400 continues at 425. If the answer is yes then any copyright information is entered at 421 after which the programmer is again prompted to enter their confidence level in the information provided at 421 by entries made at 422. At 425 a prompt on the availability of licensing information is provided. Upon receiving a negative response the process continues at 430. However, a positive response at 425 results in the process continuing at 426 wherein any licensing information in respect of the external electronic content is provided. Again the process continues at 427 requesting and receiving confidence information relating to an accuracy of licensing information entered at 426.

The process proceeds to 430 wherein a review prompt is provided, which is for accepting results and proceeding to 432 wherein the annotations entered into the external content file are presented and reviewed. At 435 a prompt is issued as to whether the confidences should be ranked. A negative response results in the process continuing at 440, and a positive response results in the process continuing at 437 wherein the confidences are ranked based upon a confidence ranking process and provided annotations.

Alternatively, at 432 the annotations are edited or amended, such as for example during a project review with a wider audience of the development team. It is evident that the confidence process at 437 weights confidences and ranks them according to the requirements of the development organization of the electronic content. For example, within one organization the annotations in respect of source of external digital content are weighted low and licensing high, whereas another organization weights them high as it wishes to ensure that no content from specific external organizations is introduced. Hence knowing with certainty that no code for example from a key competitor was embedded in the digital content.

The process continues at 440 wherein the annotations are analyzed. A potential outcome of the analysis is a decision to further amend annotations, wherein the process continues at 450. Such an event is triggered for example when all annotations are complete with very high confidence and a final project review wishes to add that the electronic content file is completed. Alternatively, the process continues at 460 wherein a content oversight team is notified of the outcome of the analysis at 450. Such a notification is triggered by events, either manually or automatically. For example, automatically triggering of the notification occurs when a URL entered at 417 is on a banned list of URLs. Another example of a trigger is external digital content has been embedded into the electronic content file with no annotation information or a very low confidence levels in the annotation.

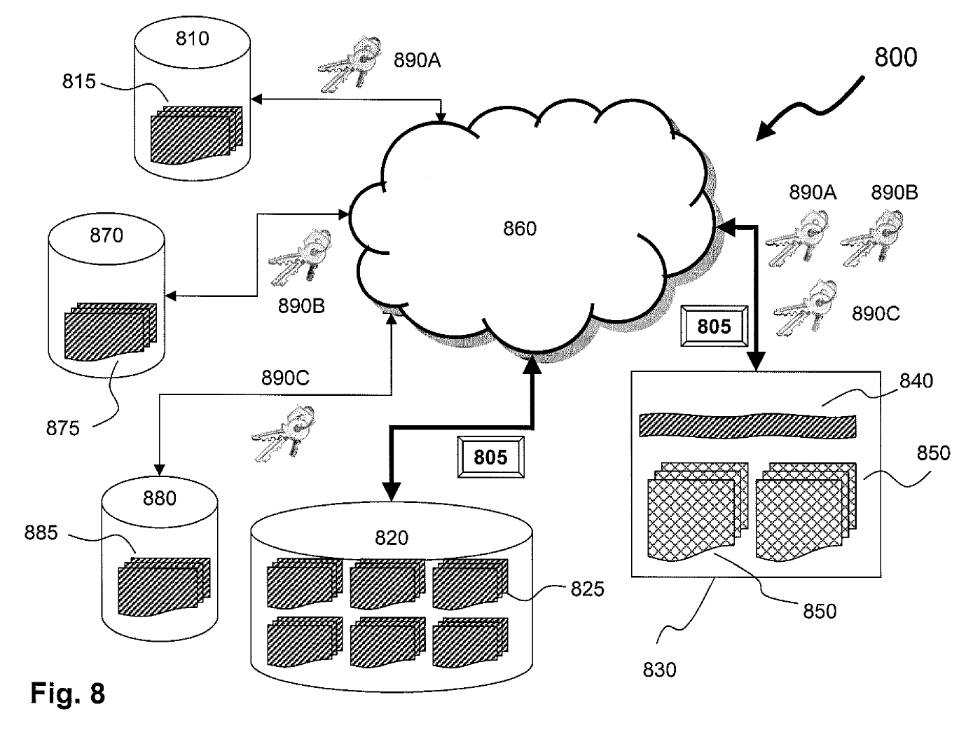

Alternatively, the result of the analysis at 440 is to trigger an external confidence process at 470. An embodiment of an external confidence process is described in respect of FIG. 8. Completion of 450 through 470 results in the process continuing at 480 wherein the modified electronic content file is accessed and the annotations transferred to an authorized client system for storage. Optionally, the transfer provides an audit trail of the electronic content file without requiring the actual electronic content file to be stored within an audit log.

Alternatively, at 480 a subset of the annotations are transferred to a server. The subset is determined for example by a rule for example relying on an outcome from 460 and 470, solely or in combination. Further, in respect of 416, 417 and 418 that result from a positive response to the query of 415, optionally the programmer does not have to provide data to one or all of these prompts. Further optionally, 416, 417, and 418 are omitted.

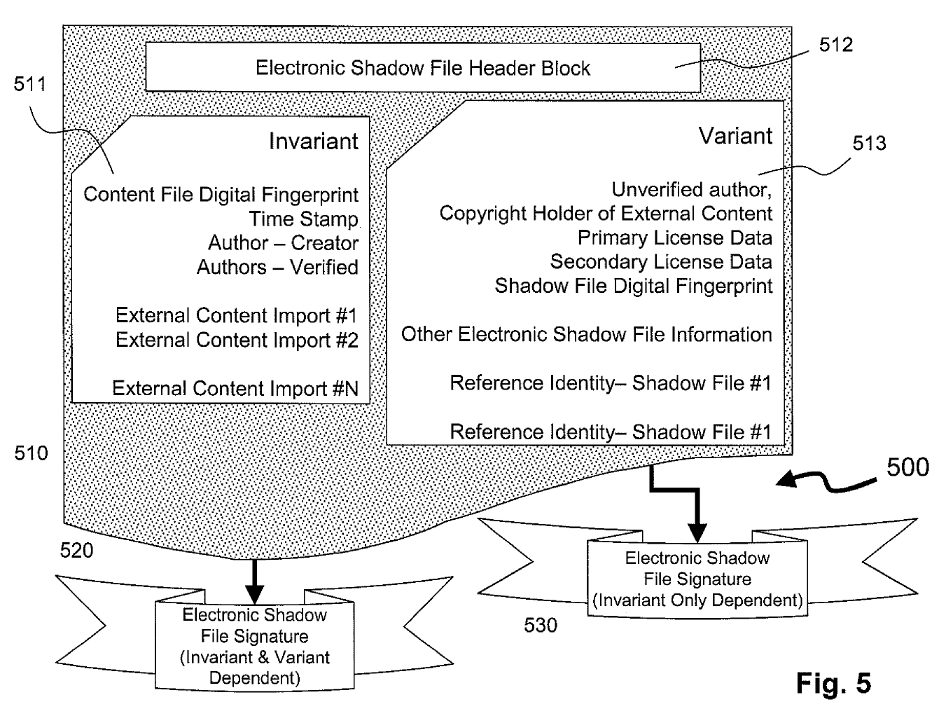

Optionally, the processes and annotations are stored in a second file separate to that of the electronic content file. Examples of such second files include databases, word processing documents, text files, spreadsheets, an electronic shadow file, or electronic signature files. An exemplary electronic shadow file is presented with reference to FIG. 5 by electronic shadow file format 510 and electronic shadow file signatures 520, 530 generated from it by a shadow file scheme 500. The electronic shadow file format 510 comprises a header block 512, which for example includes reference to the electronic content file identity, an original date and time of creation, and an identity of the developer such as organization name, division, team and project reference.

The electronic shadow file format 510 comprises two data arrays, an invariant array 511 that consists of invariant information elements and a variant array 512 that consists of variant information elements. Invariant information elements are those that do not change with the evolution of the electronic content file. Examples of such invariant information elements include, but are not limited to, a digital fingerprint of the electronic content file at a particular time, a time signature when the electronic shadow file was created, an identity of an author creating the electronic shadow file, an identity of an author creating the electronic content file; a verified author, permanent log information, and aspects of external content imported into the electronic content file.

Variant information elements are those that change over time with copying, editing, deleting, and merging in respect of the electronic content file and external content. Examples of variant information elements include, but are limited to, an unverified author, an identity of a copyright holder of external content, an aspect of a primary license associated with external content, an aspect of a license relating to external content and other than the primary license, a last modified date and time, an aspect of another electronic shadow file, and a reference identity of another electronic shadow file

An embodiment of a shadow file is shown by simplified shadow file diagram 500 and provides for two electronic shadow file signatures. The first electronic shadow file signature 520 is generated using both the invariant array 511 and variant array 512 according to a signature generating process. The second electronic shadow file signature 530 is generated according to the same process but containing only the invariant array 511. Alternatively electronic shadow file signatures are generated using predetermined portions of each of the invariant array 511 and variant array 512, or only the variant array 512. Alternatively, different processes are used to generate each signature file.

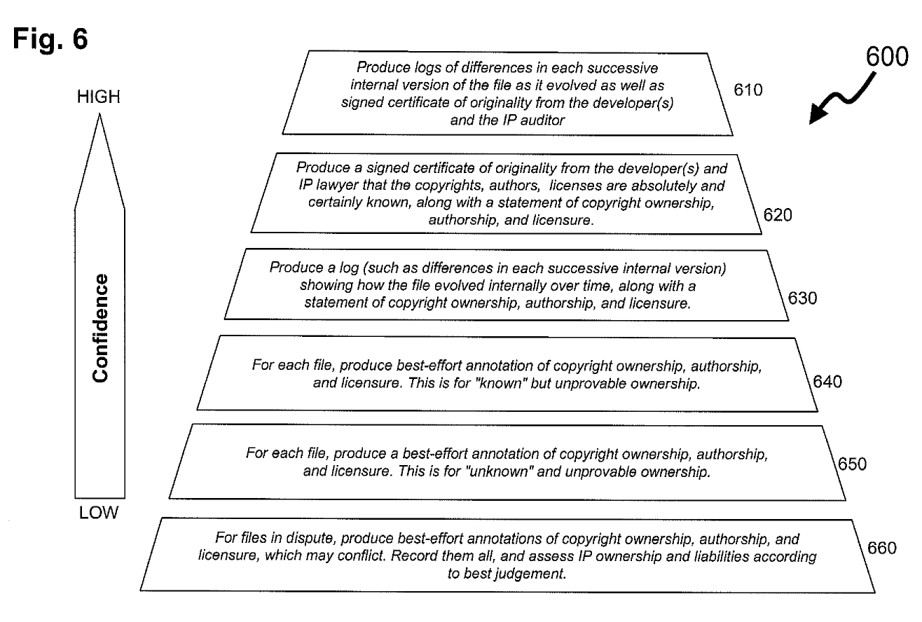

FIG. 6 depicts a schematic for various levels of confidence in copyright ownership of a digital content file. Presented at the top of the confidence pyramid 600 is a highest confidence field 610:
Produce logs of differences in each successive internal version of the file as it evolved as well as assigned certificate of originality from the developer(s) and the intellectual property auditor

This represents the highest confidence as all content is believed to be internally generated, the differences between all versions are logged and the originality is certified by the developers themselves together with the intellectual property auditor. Though there remains some risk of copying—manually entering source code written by another, this is hopefully offset by the intellectual property auditor and the honesty of the development team members individually and as a group. Coming down the pyramid a second confidence field 620 represents an introduction of external content, therein providing a greater risk of error in the chain of intellectual property. However, second confidence field 620 represents a case with a well executed rights management policy and a team capturing all external content accurately and honestly:
Produce a signed certificate of originality from the developer(s) and intellectual property lawyer that the copyrights, authors, licenses are absolutely and certainly known, along with a statement of copyright ownership, authorship, and licensure.
   Second confidence level is most clearly achieved when the content imported is of the first confidence level to a trusted party.

Third confidence field 630 has increased exposure to an organization developing electronic content as licensing, copyright information is now not known reliably. Fourth confidence field 640 has lowered confidence as now copyright, licensing of external content is ‘known’ but unprovable ownership, whilst fifth confidence field 650 lowers this even further by introducing external content of unknown ownership. Finally, at the bottom of confidence pyramid 600 is sixth confidence field 660 where best-effort annotation has been employed by the development team and the assessment of liabilities, risk of releasing the electronic content with embedded external digital content of unknown, unprovable ownership:
For files in dispute, produce best-effort annotations of copyright ownership, authorship, and licensure, which may conflict. Record them all, and assess IP ownership and liabilities according to best judgment.

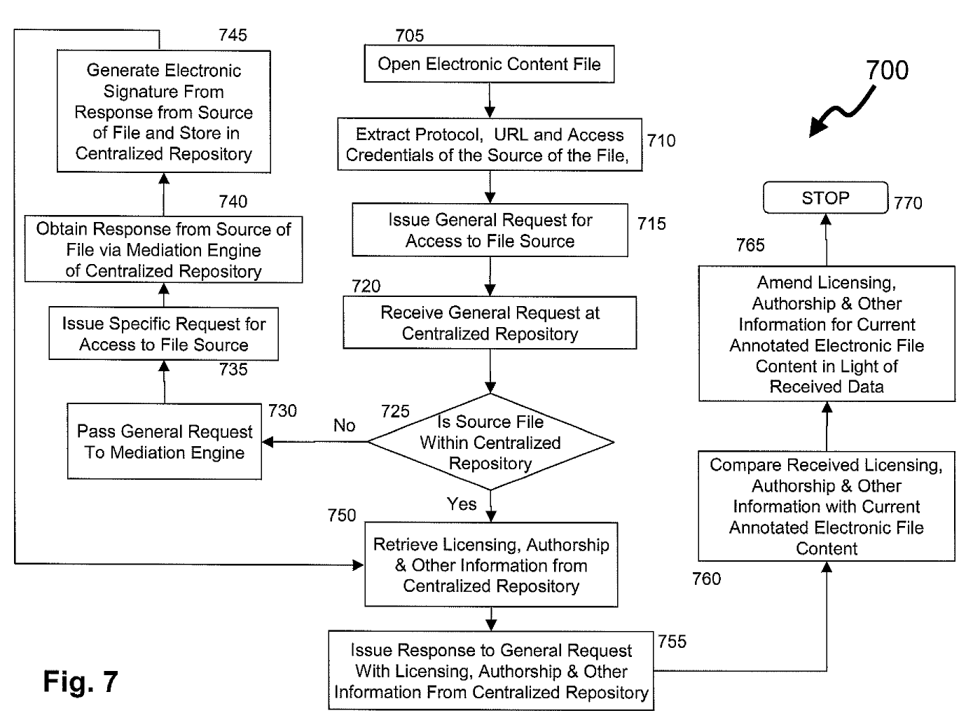

As is evident from the confidence pyramid 600 there is commercial benefit in respect of reduced potential liability to moving the confidence in the external content to higher levels within the pyramid. Increased confidence is optionally partially obtained from executing an external confidence process. An embodiment of such a process is described with reference to FIG. 7. External confidence process flow 700 begins with opening of an electronic content file at 705. At 710 protocol, URL, and access credentials for an item of embedded external digital content are extracted according to entries made during annotation of the electronic content file.

This information is then used at 720 to issue a general request for accessing the file source of the embedded external digital content to verify the information and increase the extent of this information thereby increasing confidence in the accuracy of the licensing, ownership, copyright and authorship of the embedded external digital content. The general request is typically issued to a centralized repository of digital signatures and intellectual property rights of digital content, which receives the general request at 720. At 725 the centralized repository determines whether the external digital content from the specified URL has already been logged into the centralized repository. If the centralized repository determines that the external digital content is from a source previously logged, the external confidence process flow 700 continues at 750, and if not previously logged then the process moves to 730 and the centralized repository passes the general request to a mediation engine. The mediation engine at 735 generates a specific access request using a known protocol.

The host supporting the URL and therein the source of the external digital content at 740 provides a response to the mediation engine. The response includes, for example, licensing, copyright and ownership information. This information is then extracted from the specific response at 745 and stored within the centralized repository, thereby increasing the logged external digital content of the centralized repository. The process at 750 retrieves the licensing, ownership, and copyright information from the centralized repository and then at 755 employs it to generate a general response to the general request received at 720.

The development organization issuing the general request thereby receives the licensing, ownership, and copyright information from the centralized repository at 760 and compares this with the information extracted from the electronic content file from previous annotations by the developers. At 765 the electronic content file is updated based upon the result of the comparison and the process stops 770.

Alternatively, the response to the specific request at 740 comprises a copy of the external digital content, a signature of the external digital content, or an electronic shadow file of the external digital content. Optionally, the amendment of the electronic content file at 765 comprises replacement of licensing, ownership, and copyright information previously annotated with that received from the centralized repository. Alternatively, it is augmented with the new information.

The mediation engine described at 735 allows development organizations to employ a single general format for requests and responses and provides a centralized server with the ability to engage external sources of digital content according to their specific protocol, as well as providing appropriate access privileges so that these are not exposed to other third parties. As such the mediation engine preferably supports those access protocols used by other servers. Examples of other protocols include HTTP, HTTPS, FTP, SFTP, CVS, and SVN. Examples of file formats that are usable include ZIP files, GZIP files, RAR files, and TAR files. Managing all of these access protocols and file types to provide access to other third parties is complex. Providing this at a centralized repository considerably eases the load of development organizations in establishing intellectual property rights of digital content.

Whilst the centralized repository has been presented supra in respect of storing the licensing, ownership, and copyright information based upon externally generated requests, the centralized repository optionally proactively seeks digital content to access, annotate the licensing, ownership, and copyright information and store within the centralized repository. Optionally such a proactive seeking is achieved using a WebCrawler. Referring to web searching approach 800 in FIG. 8 there is provided a mediation engine 830 that provides repository specific requests 890A through 890C in response to a generic request 805 from a centralized repository 820 hosting a WebCrawler, not shown for clarity. As shown a centralized repository 820 stores a plurality of electronic signature files 825. Each signature file 825 provides a digital signature of a an element of electronic content stored within a private repository such as private repository 810, a public repository such as public repository 870, and a limited access repository such as membership repository 880.

In order to ensure that the electronic signature files 825 are complete, up to date, and accurate, the centralized repository 820 includes a web crawler, not shown for clarity, that periodically accesses the Internet 860 to access known repositories, such as private repository 810, public repository 870 and membership repository 880, but also to identify new repositories as yet unmapped (not shown for clarity). The web crawler in this activity initiates a generic request 805 that is transmitted to the mediation engine 830 wherein it is received by mediation processor 840, which determines the correct access protocol for the repository to which the generic request 805 is addressed. The mediation processor 840 then converts generic request 805 into a repository specific request 890A though 890C using protocol, authorization, and authentication credentials that are stored within the mediation engine 830 as credential files 850.

Centralized repository 820 in addressing private repository 810 issues a generic request 805 to the mediation engine 830 wherein the mediation processor 840 accesses credential file 850 and issues a first specific request 890A to private repository 810 in respect of private digital content 815. Next the centralized repository 820 in addressing public repository 870 issues a generic request 805 to the mediation engine 830 wherein the mediation processor 840 accesses credential file 850 and issues a second specific request 890B to the private repository 870 in respect of private digital content 875.

Next, centralized repository 820 in addressing membership repository 880 issues a generic request 805 to the mediation engine 830 wherein the mediation processor 840 accesses credential file 850 and issues a third specific request 890C to private repository 880 in respect of private digital content 885. The same process is applied to a new repository once an appropriate protocol is established.

Over time, a centralized repository is able to provide responses to most general requests based upon data stored therein. Optionally, the data stored therein includes at least some of licensing, ownership, and copyright information, location and access information, digital signatures, copies of licensing and copyright documents, original source code, and electronic shadow files.

Using a centralized data store, it is likely that same digital content will be stored therein numerous times with slightly different data associated therewith. For example, an annotation with one source code hash indicates it is from “company A” and another annotation of a same hash indicates that it is from “Company A Inc.” Further, incorrect annotations will result in different records for a same hashed digital content. Preferably when the centralized data store is used to determine a source or licensor for digital content, these multiple records for a same hash are resolved, either automatically in the case of same data stored differently or manually in other cases. For automatic resolution, optionally the data is merged. Alternatively, the data with the highest confidence is selected as accurate. In an alternative embodiment, each occurrence of data for a same hash is stored and provided in response to a query and a company using the external digital content is left to resolve the occurrences. Further alternatively, a separate trusted organization mines the central data store to resolve multiple occurrences and provides a service of resolving same for other parties.

For example, if the digital content inserted were found on 150 different servers for example, 125 of which defined the digital content as a free license software executable originally generated by MacroHard and the remaining 25 define the digital content as licensable software owned by Moon Microsystems with a per-use license agreement. In this case the process may simply be a voting system. One example of a voting system would be to have users vote. Alternatively other statistical processes are employed. Further alternatively, results in the data store include data relating to a free license agreement and ownership by MacroHard leaving it to the licensee to resolve any discrepancies. As noted, in an embodiment a single record is formulated for a single hash, the single record including all annotation information whether conflicting or not.

The term signature as used herein includes hashes, digests, and secure digital signatures.

Numerous other embodiments may be envisaged without departing from the spirit or scope of the invention.

What is claimed is:

1. A method comprising:
providing a data store comprising first data stored therein, the first data comprising a plurality of records, each record having a search criteria relating to digital content and annotation data associated therewith relating to at least one of a pedigree of the digital content, licensing information relating to the digital content, and an owner of copyright in the digital content;
receiving a request comprising one of receiving first digital content and determining first search criteria therefrom and receiving first search criteria derived from first digital content;
searching the first data to retrieve annotation data associated with the first search criteria; and,
responding to the request with annotation data associated with the first search criteria.

2. A method according to claim 1 comprising:
providing a web crawler for searching for annotation data and for, when annotation data is located, creating and storing data within the first data store relating to annotation data and digital content relating to the located annotation data.

3. A method according to claim 2 comprising:
when first annotation data already is stored within the data store associated with same digital content, amending the first annotation data in dependence upon the first annotation data and the located annotation data.

4. A method according to claim 1 comprising:
resolving discrepancies between annotation data associated with a search criteria relating to same digital content.

5. A method according to claim 4 wherein resolving comprises storing all annotation data in association with a same incidence of search criteria for same digital content data.

6. A method according to claim 4 wherein resolving comprises selecting a most likely annotation data from conflicting annotations for a same digital content.

7. A method according to claim 1 wherein the data store comprises at least a server in communication with a communication network.

8. A method according to claim 1 wherein the search criteria comprises at least one of a hash of digital content and a digital signature associated with a digital content file.

9. A method according claim 1 wherein the annotation comprises confidence data relating to a measure of confidence in an accuracy of the annotation in regards to intellectual property rights of associated digital content.

10. A method according to claim 9 comprising ranking annotation data based on the confidence data therein.

11. A method according to claim 1 wherein the annotation data comprises at least one of a protocol, an address, and access credentials of a source of at least one of the first digital content and an embedded digital file forming a predetermined portion of the first digital content.

12. A method according to claim 1 wherein for each instance of stored annotation data, the annotation data is stored with an indication of being one of a certified annotation and an uncertified annotation.

13. A method according to claim 12 wherein the indication comprises a signed certificate of originality for the digital content file from at least one of an author and a proxy of the author.

14. A method according to claim 9 wherein
the confidence data is set to a predetermined value in dependence upon verifying by at least one of a manual and an automatic process that at least one of the digital content source and the digital rights associated with the digital content is accurate.

15. A method according to claim 1 comprising:
storing a pedigree log associated with a search criteria based on digital content.

16. A method according to claim 15 wherein,
the pedigree log comprises data relating to a plurality of changes to the digital content including a reference to external content when a change relates to inserting the external content into the digital content.

17. A method according to claim 16 wherein the pedigree log is certified by a trusted third party.

18. A method according to claim 1 comprising:
automatically verifying a source of the digital content by using at least one of a protocol, an address, and access credentials of the source of the digital content to access and compare the digital content to known digital content.

19. A system comprising:
a central server in communication with a communication network for storing of search data relating to digital content and annotation data in association with the search data and for accessing another server in communication with the network to retrieve annotation data therefrom in response to a request of a user, the annotation data retrieved from the another server and relayed to the user.

20. A system comprising:
computer hardware in communication with a network and for providing a data store comprising first data stored therein, the first data comprising a plurality of records, each record having a search criteria relating to digital content and annotation data associated therewith relating to at least one of a pedigree of the digital content, licensing information relating to the digital content, and an owner of copyright in the digital content;
receiving a request comprising one of receiving first digital content and determining first search criteria therefrom and receiving first search criteria derived from first digital content;
searching the first data to retrieve annotation data associated with the first search criteria; and,
responding to the request with annotation data associated with the first search criteria.
